(19) United States
(12) Patent Application Publication
(10) Pub. No.: US 2024/0377539 A1
(43) Pub. Date: Nov. 14, 2024

(54) CONTROL OF THE BRIGHTNESS OF A DISPLAY

(71) Applicant: STMicroelectronics International N. V., Geneva (CH)

(72) Inventors: Olivier Lemarchand, Grenoble (FR); Ulysse Gaffet, Grenoble (FR); Robin Vassal, Grenoble (FR)

(21) Appl. No.: 18/651,950

(22) Filed: May 1, 2024

(30) Foreign Application Priority Data
May 11, 2023 (FR) 2304677

(51) Int. Cl. G01S 17/894; G02B 27/00; G06V 10/82

(52) U.S. Cl. CPC G01S 17/894; G02B 27/0093; G06V 10/82; G09G 2320/0626

(57) ABSTRACT

The present disclosure relates to a system includes a microcontroller including a neural network, a time-of-flight sensor including a plurality of pixels and configured to perform a capture of a scene comprising a user, the capture comprising, for each pixel, the measurement of a distance from the user and of a signal value. The sensor is further configured to calculate a value of a standard deviation associated with the distance value, and a value of a standard deviation associated with the signal value and a confidence value. The sensor is further configured to provide the values to the neural network. The neural network is configured to generate, based on the values, an estimate of a direction associated with the user. The system further includes a display, the microcontroller is configured to control the display, or another circuit, based on the estimate.

### CROSS-REFERENCE TO RELATED APPLICATIONS

This application claims the priority benefit of French patent application number FR 2304677, filed on May 11, 2023, entitled “Contrôle de la luminosité d'un écran”, which is hereby incorporated by reference to the maximum extent allowable by law.

### TECHNICAL FIELD

The present disclosure relates to the control of the brightness of a display by exploitation of the data acquired with a time-of-flight sensor.

### BACKGROUND

Controlling the brightness of displays allows their power consumption to be reduced. Generally, the control is performed by monitoring, via a camera, generally via the webcam integrated on the display, the orientation of a user's head. The camera is configured to detect when the user stares towards a direction other than the display, and the brightness is then reduced, automatically setting for example the display in standby. The camera is also configured to detect when the user comes back in front of the display, and the brightness of the display is then increased.

However, operating even when the display is at a reduced operation and/or when the user is for example no more in front of its display, using the camera compromises confidentiality of the user. Further, the camera being a peripheral with a high cost in terms of power consumption, the power saving made by reducing the brightness is opposed by the power consumption of the camera.

There is a need for improving the methods for automatically adjusting the brightness of a display. Particularly, it is desirable that implementing the control of the brightness is not energy-expansive. It is further desirable that implementing the control of the brightness does not compromise the confidentiality of the user.

### SUMMARY

One embodiment provides a system comprising a microcontroller comprising a neural network; a time-of-flight sensor coupled to the microcontroller, and configured to perform a first capture of an image scene comprising a user, the sensor comprising a plurality of pixels, the first capture comprising the measurement, for each pixel, of a distance from the user of the system, and of a signal value corresponding to a number of photons returning towards the sensor per unit of time, the sensor being further configured to, subsequent to the first capture and for each pixel, calculate a value of the standard deviation associated with the distance value, and a value of the standard deviation associated with the signal value and a confidence value, the sensor being further configured to provide, to the neural network in association with each pixel, the distance, signal, and standard deviation values associated with the distance and with the signal, and the confidence value, the neural network being configured to generate, based on the values provided by the sensor, an estimate of a direction associated with the user, the system further comprising a display, coupled to the microcontroller, the microcontroller being configured to control the display, or another circuit coupled to the microcontroller, based on the estimate of the direction associated with the user.

According to one embodiment, the microcontroller is further configured to generate an attention value associated with the user, and the microcontroller is configured to control the brightness of the display further based on the attention value.

According to one embodiment, each pixel of the sensor is further configured to measure a reflectance value, and the neural network is configured to generate the estimate of the direction further based on the reflectance values.

According to one embodiment, the system further comprises a memory storing a software application, and the microcontroller is further configured to control the execution of the software application based on the estimate of the direction generated by the neural network.

According to one embodiment, the system further comprises a back light unit (BLU), and the microcontroller is configured to deactivate the back light unit, based on the estimate of the direction.

According to one embodiment, the microcontroller is configured to control a refresh rate of the display based on the estimate of the direction.

According to one embodiment, the sensor is configured to perform, subsequent to the first capture, a second capture, the time interval between the first and second captures being determined by the estimate of the direction generated by the neural network and/or based on the attention value calculated subsequent to the first capture.

According to one embodiment, the sensor is an 8*8 pixels sensor.

According to one embodiment, the preceding system further comprises at least one further display, the microcontroller being further configured to control the brightness of the at least one further display based on the estimate of a direction associated with the user.

According to one embodiment, the estimated direction is a direction describing the orientation of the head of the user, among the North, North-East, North-West, East, West, and South directions, the North direction indicating that the user is facing the display and the South direction indicating that the user has their back facing the display.

According to one embodiment, the microcontroller is configured to control the decrease of the brightness of the display when between at least two consecutive captures, the estimated direction transitions:
from North to North-West, or to North-East; and/or
from North to South; and/or
from North-West or North-East to South,
   and wherein the microcontroller is configured to control the increase of the brightness of the display when, between at least two consecutive captures, the estimated direction transitions:
from South to North; and/or
from South to North-West, or from South to North-East; and/or
from North-West or North-East to North.

According to one embodiment, the confidence value is a Boolean value indicating whether the measurements performed by the pixel allow the user to be detected, the sensor being configured to not provide to the neural network the measurements acquired by a pixel that does not detect the user.

According to one embodiment, the neural network comprises: at least one convolutional layer; and at least one dense layer.

One embodiment provides a method for learning a neural network comprising:
capturing, by a time-of-flight sensor, a plurality of image scenes comprising a user of a display, each pixel measuring a value of a distance from the user, a signal value, and being configured to calculate a standard deviation associated with the distance value and a standard deviation associated with the signal value;
removing, by a processor, in the captured images, abnormal images;
classifying, by the processor, each non-removed image, in a class among the North, North-West, North-East, West, East, and South classes;
balancing, by the processor, the number of images distributed in each class;
selecting, by the processor, an architecture of a neural network; and
training the neural network based on captured and classified images, and based on the values measured for each image pixel, the training comprising searching for parameters of the selected neural network.

One embodiment provides a method comprising: capturing, by a time-of-flight sensor, an image scene comprising a user of a display, capturing comprising measuring, by each sensor pixel, a distance value, a signal value, and standard deviation values associated with the distance value and with the signal value, the sensor being further configured to generate, for each pixel, a confidence value; providing, by the sensor to a microcontroller, the measurements performed by the pixels, the microcontroller comprising a neural network configured to estimate, based on the provided measurements, a direction describing the orientation of the user's head; and controlling, by the microcontroller, the display, or another circuit coupled to the microcontroller, based on the estimate of the orientation of the user's head.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a block-scheme illustrating a system comprising a display and a time-of-flight sensor, according to one embodiment of the present description;

FIG. 2 illustrates processing data acquired by the time-of-flight sensor in order to estimate the orientation of the head of a user of the system, according to one embodiment of the present description;

FIG. 3 illustrates calculating, for each pixel of the time-of-flight sensor, data used for estimating the orientation of the user's head;

FIG. 4 illustrates example applications implemented subsequent to the estimate of the orientation of the user's head;

FIG. 5 is a flow-chart illustrating steps of a method for processing data acquired by a time-of-flight sensor;

FIG. 6A illustrates an embodiment of a method for estimating the attention of a user of the system, according to one embodiment of the present description;

FIG. 6B illustrates another embodiment of a method for estimating the attention of a user of the system, according to one embodiment of the present description; and

FIG. 6C illustrates another embodiment of a method for estimating the attention of a user of the system, according to one embodiment of the present description.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the operation of a time-of-flight sensor is known by those skilled in the art, and has not been described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

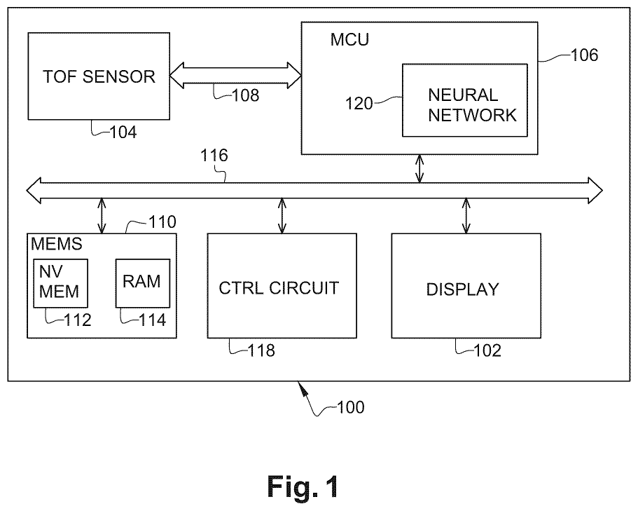

FIG. 1 is a block-scheme illustrating a system 100 comprising a display (DISPLAY) 102 and a time-of-flight sensor (TOF SENSOR) 104, according to one embodiment of the present description.

As an example, the system 100 illustrates a laptop, or a desktop computer. While a single display is illustrated in relation with FIG. 1, the system 100 can comprise several, e.g. two or three, displays. In further examples, the system 100 is a mobile phone, a pad, an advertising display, an automated teller machine, and more generally any system comprising a display and a time-of-flight sensor.

The system 100 further comprises a microcontroller 106 (MCU) coupled to the time-of-flight sensor 104 via a bus 108. As an example, bus 108 is a bus of the I2C (Inter-Integrated Circuit) type.

Further, the system 100 for example comprises memories 110 (MEM) for example comprising a non-volatile memory 112 (NV MEM) and/or a volatile memory 114 (RAM). As an example, the non-volatile memory 112 is a Flash-type memory, and the memory 114 is a random access volatile memory. As an example, the memories 110 are coupled to the microcontroller 106 via a bus 116.

As an example, the system 100 further comprises a control circuit 118 (CTRL CIRCUIT), coupled to the bus 116, and configured to control the brightness of the display 102.

According to one embodiment, the microcontroller 106 comprises a neural network 120 (NEURAL NETWORK). The neural network 120 is configured to estimate, based on the data acquired by the time-of-flight sensor 104, the orientation of the head of a user of the system 100, and particularly of the display 102.

As an example, subsequent to the estimate of the user head orientation, the microcontroller 106 controls adjusting the brightness of the display 102. As an example, adjusting the brightness of the display 102 is performed via the control circuit 118.

As an example, the microcontroller 106, and/or the control circuit 118, is configured to cause decreasing the brightness of the display 102 when the estimate of the head orientation shows that the user looks away from the display 102. When the estimates show that the user does not look towards the display 102, the microcontroller 106, and/or the control circuit 118, is configured to leave as is, or again decrease, the brightness of the display 102. Oppositely, when the estimates show that the user looks again, or comes back, towards the display 102, the microcontroller 106, and/or the control circuit 118, is configured to cause increase the brightness of the display 102. Similarly, when the estimates show that the user stays in front of the display, the microcontroller 106, and/or the control circuit 118, is configured to leave as is the brightness.

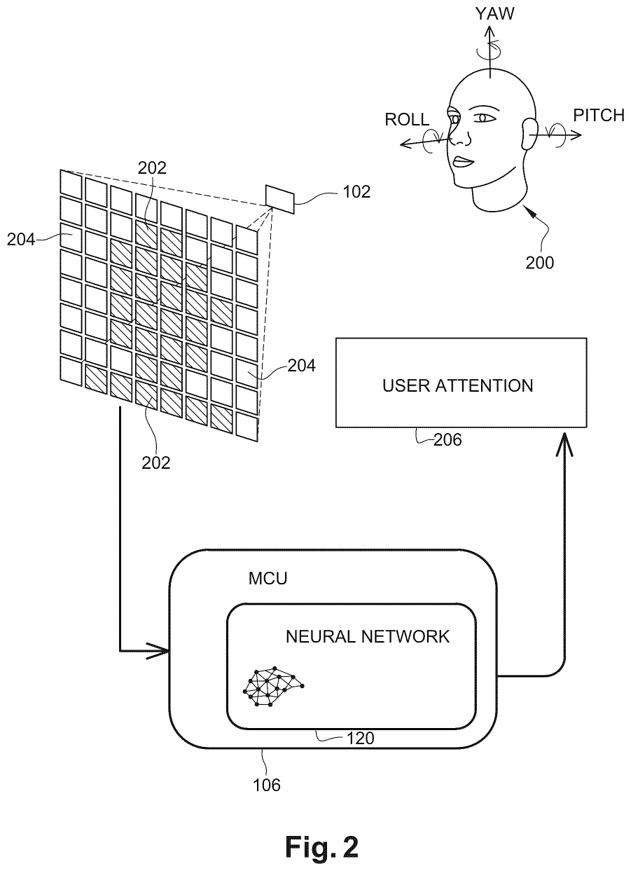

FIG. 2 illustrates processing the data acquired by the time-of-flight sensor 102 in order to estimate the orientation of the head of a user 200 of the system 100, according to one embodiment of the present description.

According to one embodiment, the time-of-flight sensor 104 comprises a plurality of pixels. In the example shown in FIG. 2, the time-of-flight sensor 104 comprises 64 pixels, arranged in a square having 8 pixels per side.

The user 200 is for example in front of the time-of-flight sensor 104. The user 200 can move the head according to rotational movements around 3 axis x,y,z: a rotation around z-axis (YAM) corresponding to turning the head to the right or left. A rotation around y-axis (ROLL) corresponds to rotate the head in a plane parallel to the user 200, i.e. to cause the head rotate towards a shoulder without rotating the same to the right or left. Lastly, a rotation around the x-axis (PITCH) corresponds to lower the head to the ground, or to raise the head to the sky.

During a capture performed by the sensor 104, each pixel of the sensor 104 measures different information. As an example, the pixels of the sensor 104 are configured to measure inter alia a distance between the sensor 104 and a target facing the sensor 104. The target, such as the user 200, does not necessarily occupy the whole field measured by the sensor. Thus, the pixels 202 will detect the user 200, when for example the measured distance is a finite value, or a value less than a threshold value. Other pixels 204 will not detect user 200, and are for example associated with the background of the captured scene.

According to one embodiment, subsequent to the measurements performed for each pixel, a state value is further generated for each pixel. As an example, the state value is a Boolean value having for example the true value (TRUE) when the measured distance indicates that the user 200 was detected by the pixel. The state value has for example the false value (FALSE) when the measured values by the pixel are abnormal. As an example, when the user 200 is not detected, the value FALSE is allocated to the pixel.

In the example illustrated in FIG. 2, the state values of the pixels 202 are allocated to the value TRUE, and the state values of the pixels 204 are allocated to the value FALSE.

In another example, the state value is a value belonging to an interval, i.e. [0, 100]. The state value then represents a confidence index of the pixel.

According to one embodiment, the performed measurements by the pixels 202 are forwarded to the microcontroller 106, and are processed by the neural network 120. The microcontroller 106 is then configured to generate, based on the received measurements, estimates 206 (USER ATTENTION). The estimates 206 comprise an estimate, by the neural network 120, of the orientation of the user's head. As an example, the estimate of the orientation takes the form of an angle or a direction. The estimates 206 for example comprise an estimate, by the microcontroller 106, of the user attention. As an example, the estimate of the attention is a Boolean value taking the value FALSE when the user is not paying attention, and the value TRUE when the user pays attention. In another example, the estimate of the user attention is a value belonging to an interval. As an example, the considered interval is the interval [0, 100], the value o indicating that the user pays no attention at all, and the value 100 indicating that the user concentrates on the display 102. The interval [0,100] is given by way of example and not limitation, other user attention intervals or measurements could be considered. The user attention is for example estimated based on the user head orientation estimated by the neural network 120.

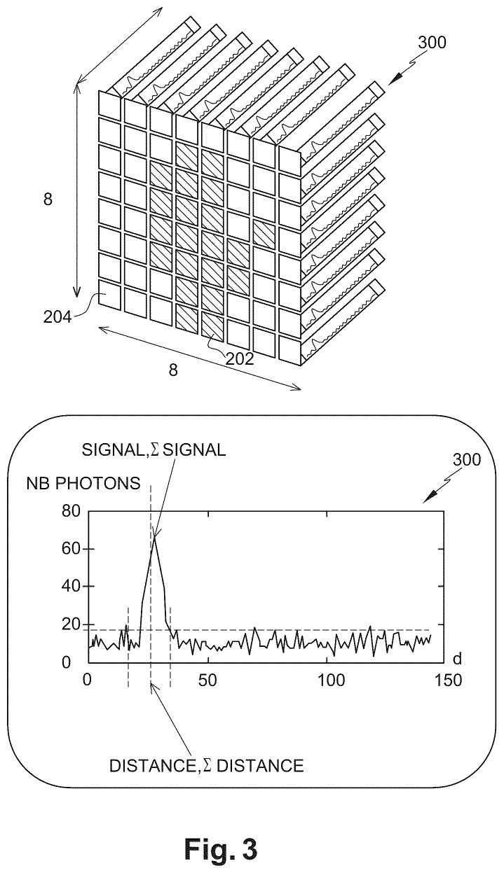

FIG. 3 illustrates calculating, for each pixel of the time-of-flight sensor 104, data used for estimating the user head orientation. As an example, the used data are directly calculated by the sensor 104, based on measurements performed by the pixels.

The time-of-flight sensor 104 is configured to transmit light pulses, generally in the infrared field, towards a scene. For each pulse, the light reflected by objects, here by the user 200 of the system 100, located in the scene is detected, by each pixel. As an example, each pixel comprises one or more light sensitive elements configured to detect the reflected light. As an example, the light sensitive elements are single photon avalanche diodes (SPAD). Generally, to obtain a suitable signal-to-noise ratio, each pixel of the time-of-flight sensor 104 is configured to accumulate the signal generated by the one or more photosensitive elements during a series of several thousand of light pulses, emitted from the sensor 104. A distance (DISTANCE) in mm, between the user 200 and the sensor 104 is then deduced based on an average duration of the pulse series.

A graph 300 illustrates, for a pixel of the sensor 104, the accumulation of the signals generated by the one or more photosensitive elements during a series of several thousand of light pulses. An axis d represents the measured distances during each flow and an axis NB PHOTONS represents the number of photons that came back per second. A signal value (SIGNAL) corresponds to the average value of the number of photons returning to the pixel per second.

According to one embodiment, each pixel is further configured to calculate a standard deviation associated with the distance (>DISTANCE), and a standard deviation associated with the signal (>SIGNAL).

As an example, each pixel is further configured to measure a reflectance value. As an example, the reflectance value is a percent calculated based on the number of photons sent back by the target, and based on the distance from the estimated target. As an example, human skin, whatever its tone, has a reflectance of around 60%. As an example, hairs have a reflectance of at least 10%, according to their color.

As an example, the reflectance values of the pixels having as state value the value TRUE, or a value higher than the threshold value, are forwarded to the microcontroller 106.

According to one embodiment, the sensor 104 is configured to forward to the microcontroller 106 the values of distance, of signal, of distance standard-deviation, and of signal standard-deviation of the pixels, and the state values, for each pixel. As an example, when the state value associated with a pixel is equal to the value FALSE, the microcontroller 106 ignores the other values associated with this pixel. The subject pixel is for example processed by the microcontroller 106 as being an invalid pixel. In the example where the state value belongs to an interval, the measurements of the pixels having as state value a value less than a threshold value are for example ignored by the microcontroller 106.

As an example, the measurements of distance, signal, standard deviations, and reflectance of the invalid pixels are automatically allocated, by the microcontroller 106, to default values, for example to o, or to a not-a-number (NaN) value.

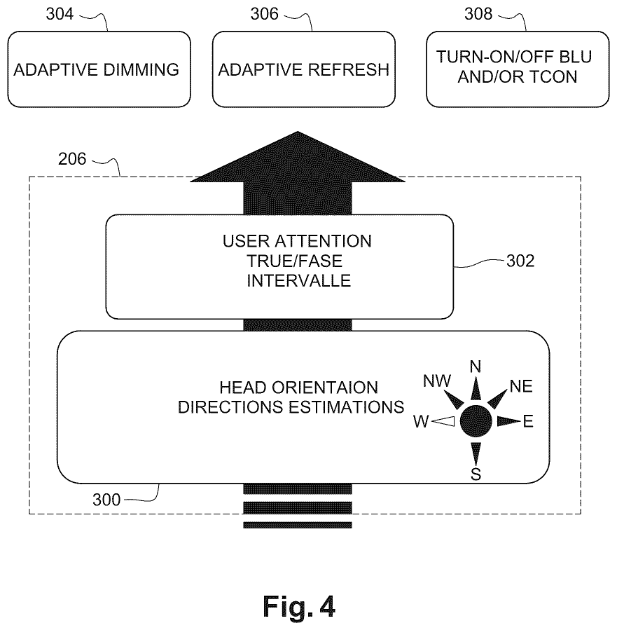

FIG. 4 illustrates example applications implemented subsequent to the data processing.

As an example, the estimates 206, comprising an estimate 300 (HEAD ORIENTATION DIRECTIONS ESTIMATIONS) the orientation of the head of the user 200, and an estimate 302 (USER ATTENTION TRUE/FALSE INTERVAL) of the attention of the user 200, are used, for example by the microcontroller 106, or by another processor (not shown in FIG. 1), to implement one or more applications 304 (ADAPTIVE DIMMING), 306 (ADAPTIVE REFRESH), and/or 308 (TURN-ON/OFF TBLU AND/OR TCON).

As an example, the estimate 300 of the user head orientation for example takes the form of a direction among the North (N), North-East (NE), North-West (NW), East (E), West (W), and South(S) directions. The North direction for example indicates that the user is facing the display 102. The East and West directions for example respectively indicate that the user looks 90° at the right and at the left of the display 102. The South direction for example indicates that the user has their back facing the display 102.

Implementing the application 304 allows adjusting the brightness of the display 102 according to the attention and head orientation of the user's head. As an example, the memory 112 comprises instructions allowing implementing the application 304.

Implementing the application 306 for example allows slowing down, or accelerating, the refresh rate of the display 102 according to the estimates 206. As an example, when it is estimated that the user does not face the display 102, the refresh rate of the display is less than when it is estimated that the user is facing the display.

Implementing the application 308 for example allows switching on or off circuits (not shown in FIG. 1) peripheral to the system 100. As an example, when the estimates 206 show that the user does not face the display and/or that the user does not pay attention, peripheral circuits are switched off. The circuits are switched on back when the estimates show that the user comes back in front of the display 102 and/or pays again attention. As an example, the peripheral circuits comprise a T-CON (Timing Control) board and/or a black light unit BLU.

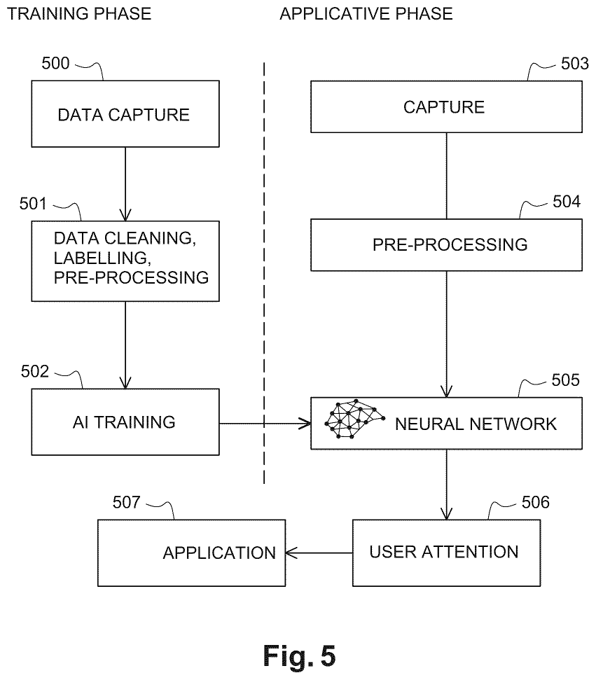

FIG. 5 is a flow-chart illustrating steps of a method for processing data acquired by a time-of-flight sensor.

Particularly, the flow-chart described in relation with FIG. 5 comprises two phases. A training phase (TRAINING PHASE) comprises building the neural network 120 and its training. The training phase is for example performed before the manufacturing of the system 100. The training phase for example comprises steps 500 to 502. An applicative phase (APPLICATIVE PHASE) comprises the implementation of the neural network 120 by the system 100. As an example, the applicative phase comprises steps 503 to 507.

Step 500 (DATA CAPTURE) of the training phase comprises acquiring a plurality of captures by one or more time-of-flight sensors similar to the sensor 104. Acquiring a plurality of captures comprises capturing by the one or more sensors a plurality of image scenes. The captured scenes for example comprise a user of a display, the used sensors being for example integrated into the subject display.

Each capture comprises the measurement, by each pixel, of the distance, of the signal, as well as standard deviations associated with the distance and with the signal. As an example, each capture further comprises the measurement, by each pixel, of the reflectance.

In a step 501 (DATA CLEANING, LABELLING, PRE-PROCESSING), the captures performed in step 500 are for example preprocessed. As an example, the step 501 comprises a cleaning step. Cleaning the captures for example comprises removing all the captures where none user appears, or where several users appear. As an example, cleaning further comprises removing the captures comprising NaN values for the one or more performed measurements. Further, the step 501 for example comprises a labelling step. As an example, the labelling step comprises associating each of the captures, being not removed during cleaning, with a direction among the North, North-East, North-West, East, West, and South directions. Further, the step 501 for example comprises a balancing step, wherein the number of captures allocated to each direction is balanced. In other words, performing balancing allows having a same number of captures associated with each direction.

In step 502 (AI TRAINING), an architecture of the neural network is sought. As an example, this step is performed, for example, by computer and via an architecture-seeking tool.

Subsequent to selecting a neural network, the step 502 further comprises training the neural network, for example, by computer and via a calculation tool, or via the architecture-seeking tool. Training the selected neural network allows the parameters involved in the network, such as the synaptic weights for dense layers, a number of filters for a convolution layer, etc. to be optimized. The selected and trained neural network is then the neural network 120.

The neural network 120 is then implemented, for example, in the microcontroller 106 of the system 100.

As an example, the neural network 120 comprises an input layer configured to receive input data. Input data are for example in association with each pixel of the sensor 104, the at least 4 measurements: distance, signal, and standard deviations associated with the distance or signal. As an example, the reflectance measurements are also forwarded to the neural network 120. In another example, the state values are also forwarded to the neural network 120. The number of input data is then equal to the number of pixels of the sensor 104 multiplied by the number of measurements performed by each pixel. Values associated with the invalid pixels were allocated by the microcontroller 106, to default values, such as null values or not-a-number values. Further, the neural network 120 for example comprises, after the input layer, two convolution layers. As an example, the first convolution layer comprises a filter number equal to a number of measurements forwarded by each pixel. As an example, the second convolution layer comprises 2 filters. The neural network 120 further comprises, following the convolution layers, a flattening layer. As an example, during the step 502, a so-called dropout layer and/or a Gaussian noise layer are summated in order to reduce the over-training of the neural network 120.

As an example, the neural network 120 further comprises two dense layers. The first dense layer has for example a number of neurons equal to the number of output neurons in the second convolution layer. The second dense layer has, for example, a number of neurons equal to the number of directions that a user's head may have. As an example, the second dense layer comprises 6 neurons. The neural network 120 is configured to generate, for each of the directions among North, North-East, North-West, East, West, and South, a likelihood of belonging, based on the input data. The most likely direction is then the estimate of the user head orientation.

The considered example of the neural network 120 is not given by way of limitation, and naturally other architectures can be implemented. Nevertheless, in case where the sensor 104 comprises a reduced number of pixels, for example when the sensor comprises less than a hundred of pixels, it is desirable that the neural network 120 has a small size. As an example, the neural network 120 comprise less than about ten layers. Indeed, a neural network 120 of small size allows a contribution to energy savings of the system 100, and particularly when the display 102 has a low brightness, and that the user is not facing the display 102.

Subsequent to implementing the neural network 120 in the microcontroller 106, and during operation of the system 100, a step 503 (CAPTURE) of the applicative phase comprises a capture by the sensor 104 described in relation with FIG. 3. The measurements performed during the capture are for example forwarded to the microcontroller 106.

In a step 504 (PRE-PROCESSING), the microcontroller 106 performs a processing of the received measurements. As an example, processing comprises identifying the pixels 202 detecting the user of the display 102. As an example, pixels having a state value TRUE, but not being identified as detecting the user of the display 102, have their state value reallocated to the value FALSE. Measurements performed for these pixels are then replaced with the default values. Further, the step 504 for example comprises normalizing these measurements. As an example, the values of the distances are normalized in order to belong to an interval, e.g. interval [-1,1].

In a step 505, measurements of the pixels are provided as input data into the neural network 120. As an example, these measurements were again normalized when performing step 504. As an example, the values associated with the invalid pixels are default values. The neural network 120 is then configured to, based on the provided input data, estimate the orientation of the head of the user of the display 102, for example among the North, North-East, North-West, East, West, and South directions.

In a step 506 (USER ATTENTION), the attention value is calculated for example by the microcontroller 106, based on the user head orientation. As an example, the sensor 104 is configured to perform several measurements, at times being spaced from each other with a regular time interval, or with a time interval depending on the estimates performed by the neural network 120. In association with each time, the neural network 120 estimates the user head orientation, and this estimate is for example stored in a volatile memory. Further the value of the user attention at a given time is for example calculated based on at least two estimates of the user head orientation for prior times.

In a step 507 (APPLICATION), the estimate of the orientation of the head of the user 200, and the attention value are for example used, by the microcontroller 106, or by another processor, to implement one or more applications such as for example the applications 304, and/or 306, and/or 308.

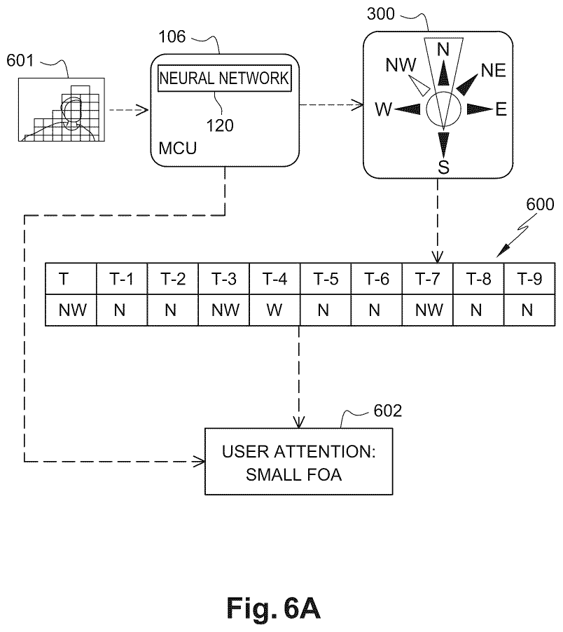

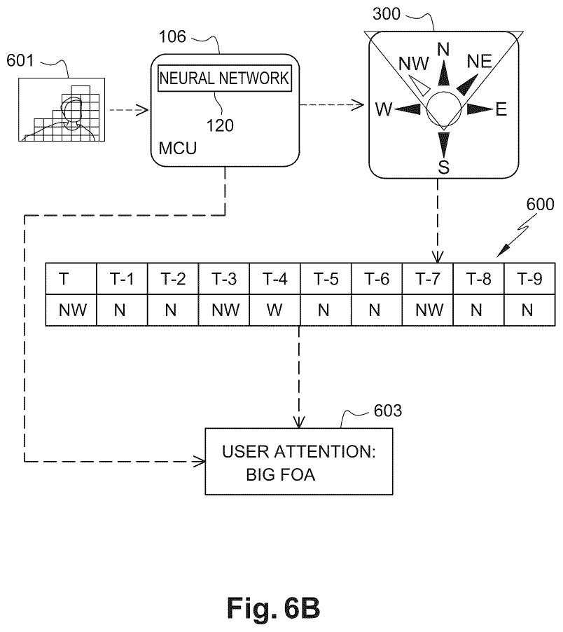

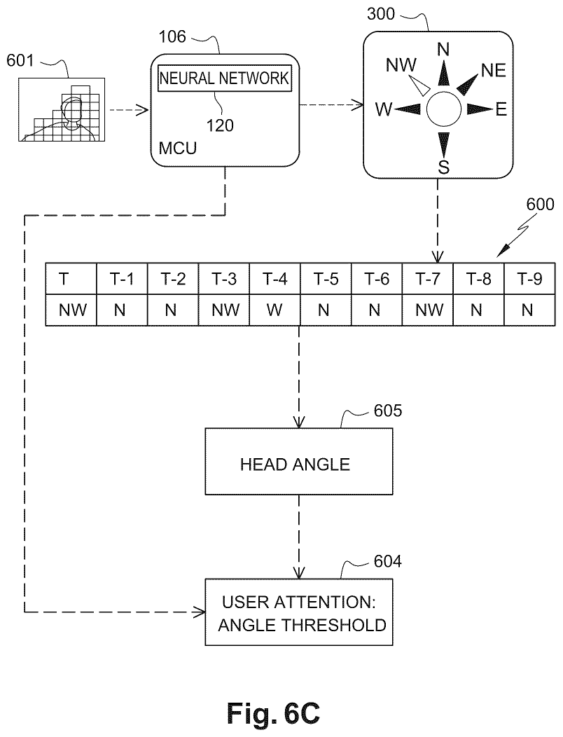

FIGS. 6A, 6B, and 6C illustrate embodiments of a method for estimating the attention of a user of the system, according to one embodiment of the present description.

As an example, the system comprises a volatile memory, such as for example a circular buffer, or a first in, first out (FIFO) memory. As an example, the volatile memory is comprised in the microcontroller 106. In another example, the volatile memory is comprised in memories 110. At each direction estimate, by the neural network 120, the volatile memory is configured to store this direction. Thus, at each new direction estimate, by the neural network 120, the volatile memory is configured to remove the least recent, and to store the new direction. The directions stored by the volatile memory come thus from consecutive captures by the sensor 104. As an example, the volatile memory is configured to store a number n of directions, for example 10 directions. The size of the volatile memory can naturally change, and it can store a number higher than 10 consecutive direction estimates, or a number less than 10 consecutive direction estimates.

In the examples illustrated in FIGS. 6A, 6B, and 6C, the volatile memory is represented with a table 600. The table 600 comprises 10 consecutive direction estimates, generated by the neural network 120. As an example, the 10 direction estimates were performed from captures of an image scene 601 by the sensor 104, performed at consecutive times T-9 to T. In the example illustrated in FIGS. 6A, 6B, and 6C, the direction estimated for time Tis the North-West direction, the direction for the time T−1 is the North direction, etc.

As an example, the attention value is a value belonging to an interval, for example the interval [0,100]. The interval [0,100] is given only by way of example, and any other interval could be considered, such as for example an interval having the form [0,1], [−1,1], etc. Generally, the confidence interval is characterised by a minimum value and a maximum value.

In a first embodiment 602 (USER ATTENTION: SMALL FOA), illustrated in FIG. 6A, the attention value is set at the maximum value when the presence of the user of the display 102 is detected, and at least one among the following conditions is satisfied:
the North direction was estimated for the times T and T−1; or
the North direction was estimated at least six times among the estimates for the times T−9 to T; or
the distance between the user 200 and the display 102, measured by the sensor 104, is less than a reference distance, the reference distance value for example being less than 500 mm. As an example, the reference distance value is equal to 320 mm. As an example, the user presence is detected by applying a detection algorithm, such as for example a human versus object detection (HOD) algorithm.

When none of the above conditions is satisfied, the attention value gradually decreases. As an example, the attention value decreases from the maximum value down to the minimum value within a reference time period. As an example, the reference time period is around a few seconds, for example between 2 and 3 seconds.

In a second embodiment 603 (USER ATTENTION: BIG FOA), illustrated in FIG. 6B, the attention value is set at the maximum value when the presence of the user of the display 102 is detected, for example following the application of an algorithm of the HOD type, and at least one among the following conditions is satisfied:
the North direction was estimated for the times T and T−1; or
the sum of the North, North-West, and North-East directions among the estimates for the times T−9 to Tis at least equal to 8; or
the distance between the user 200 and the display 102, measured by the sensor 104 is less than a reference distance, the reference distance value for example being less than 500 mm. As an example, the reference distance value is equal to 320 mm.

When none of the above conditions is satisfied, the attention value gradually decreases. As an example, the attention value decreases from the maximum value down to the minimum value within a reference time period. As an example, the reference time period is around a few seconds, for example between 2 and 3 seconds.

In a third embodiment 604 (USER ATTENTION: ANGLE THRESHOLD), illustrated in FIG. 6C, the directions stored in the volatile memory 600 are used to calculate an angle 605 (HEAD ANGLE). As an example, the calculated angle is an angle between −180° and 180°, and corresponds to an average of all the directions stored in the volatile memory. As an example, each direction is converted in an angle, for example, the North direction corresponds to an angle of 0°, the North-East and North-West directions respectively correspond to an angle of −45° and 45°. The East and West directions respectively correspond to an angle of −90° and 90°. The South direction corresponds to an angle of 180°, or to an angle of −180°.

The attention value is then set at the maximum value when the presence of the user of the display 102 is detected, for example following the application of an algorithm of the HOD type, and that at least one among the following conditions is satisfied:
the calculated angle belongs to reference interval, the reference interval for example being a symmetric interval, with the form [−θ,θ], where θ is an angle less than 180°. In an example, θ is less than 90°, or than 45°. In another example, the angle θ is smaller, and for example is less than 30°, or even than 20°; or
the distance between the user and the display 102, measured by the sensor 104, is less than a reference distance, the reference distance value for example being less than 500 mm. As an example, the reference distance value is equal to 320 mm.

When none of the above conditions is satisfied, the attention value gradually decreases. As an example, the attention value decreases from the maximum value down to the minimum value within a reference time period. As an example, the reference time period is around a few seconds, for example between 2 and 3 seconds.

As an example, in the embodiments described in relation with FIGS. 6A, 6B, and 6C, the brightness of the display gradually decreases with the attention value. As an example, the display 102 is set in standby mode as the attention value reaches the minimum value.

One advantage of the described embodiments is that the user head orientation estimate is performed based on measurements performed by a time-of-flight sensor, far less energy consuming than a camera. In addition, using the time-of-flight sensor allows the user confidentiality to be guaranteed.

Another advantage of the described embodiments is that, using a time-of-flight sensor, the neural network configured to data process has an extremely small size, for example less than about ten layers, and less than 100,000 parameters, thus allowing not using too many energy resources.

Another advantage of the described embodiments is that the estimate are performed, inter alia, based on a distance measurement, which allows obtaining, for a number of pixels relatively small as compared to the resolution of an image from a camera, estimates having a reliability similar to those obtained based on images from a camera.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove. In particular, concerning adapting, according to the estimates performed by the neural network, the brightness of the display can change. Similarly, the calculation of the user attention and its use can change. In addition, the system can comprise several displays. In such case, a reference display is a display at which the user looks most of the time. The reference display does not necessarily comprises the time-of-flight sensor configured to perform the captures. Those skilled in the art will be able to calibrate the sensor in order that the estimates performed by the neural network correspond to the user head orientation as compared to the reference display. Similarly, when the system comprises several displays, the user can look at a display other than the reference display without meaning he pays no attention. Those skilled in the art will be able to adjust according to the system configuration the brightness control and/or the implementation of application such as for example the applications described in relation with FIG. 3.

What is claimed is:

1. A system comprising:
a microcontroller comprising a neural network;
a time-of-flight (ToF) sensor coupled to the microcontroller and comprising a plurality of pixels, the ToF sensor being configured to
perform a first capture of an image scene comprising a user, the first capture comprising, for each pixel, a measurement of a distance from the user of the system and of a signal value corresponding to a number of photons returning towards the sensor per unit of time,
subsequent to the first capture and for each pixel, calculate a value of the standard deviation associated with the distance value, and a value of the standard deviation associated with the signal value and a confidence value, and
provide, to the neural network in association with each pixel, the distance, signal, and standard deviation values associated with the distance and with the signal, and the confidence value, and
the neural network being configured to generate, based on the values provided by the sensor, an estimate of a direction associated with the user; and
a display coupled to the microcontroller, the microcontroller being configured to control the display, or another circuit coupled to the microcontroller, based on the estimate of the direction associated with the user.

2. The system according to claim 1, wherein each pixel of the sensor is further configured to measure a reflectance value, and wherein the neural network is configured to generate the estimate of the direction further based on the reflectance values.

3. The system according to claim 1, further comprising a memory storing a software application, and wherein the microcontroller is further configured to control execution of the software application based on the estimate of the direction generated by the neural network.

4. The system according to claim 1, further comprising a backlight unit (BLU), and wherein the microcontroller is configured to deactivate the backlight unit based on the estimate of the direction.

5. The system according to claim 1, wherein the microcontroller is configured to control a refresh rate of the display based on the estimate of the direction.

6. The system according to claim 1, wherein the ToF sensor is configured to perform, subsequent to the first capture, a second capture, the time interval between the first and second captures being determined by the estimate of the direction generated by the neural network, and/or based on an attention value calculated subsequent to the first capture.

7. The system according to claim 1, wherein the microcontroller is further configured to generate an attention value associated with the user, and wherein the microcontroller is configured to control the brightness of the display further based on the attention value.

8. The system according to claim 7, wherein the ToF sensor is configured to perform, subsequent to the first capture, a second capture, the time interval between the first and second captures being determined based on the attention value calculated subsequent to the first capture.

9. The system according to claim 1, further comprising at least one further display, the microcontroller being further configured to control the brightness of the at least one further display based on the estimate of a direction associated with the user.

10. The system according to claim 9, wherein the estimate of the direction is a direction describing the orientation of the head of the user, among the North, North-East, North-West, East, West, and South directions, the North direction indicating that the user is facing the display, and the South direction indicating that the user has their back facing the display.

11. The system according to claim 10, wherein the microcontroller is configured to control the decrease of the brightness of the display when, between at least two consecutive captures, the estimate of the direction transitions:
from North to North-West or to North-East; and/or
from North to South; and/or
from North-West or North-East to South,
and wherein the microcontroller is configured to control the increase of the brightness of the display when, between at least two consecutive captures, the estimate of the direction transitions:
from South to North; and/or
from South to North-West or from South to North-East; and/or
from North-West or North-East to North.

12. The system according to claim 1, wherein the confidence value is a Boolean value indicating whether the measurements performed by the pixel allow the user to be detected, the sensor being configured to not provide to the neural network the measurements acquired by a pixel that does not detect the user.

13. The system according to claim 1, wherein the neural network comprises:
at least one convolutional layer; and
at least one dense layer.

14. A method comprising:
capturing, by a time-of-flight (ToF) sensor comprising a plurality of pixels, a plurality of image scenes comprising a user of a display, each pixel measuring a value of a distance from the user, a signal value, and being configured to calculate a standard deviation associated with the distance value, and a standard deviation associated with the signal value;
removing, by a processor, in the captured images, abnormal images;
classifying, by the processor, each non-removed image, in a class among the North, North-West, North-East, East, West, and South classes;
balancing, by the processor, the number of images distributed in each class;
selecting, by the processor, an architecture of a neural network; and
training the neural network based on the captured and classified images, and based on the values measured for each image pixel, the training comprising searching for parameters of the selected neural network.

15. The method according to claim 14, further comprising:
performing a first capture of an image scene comprising a user, the first capture comprising, for each pixel, a measurement of a distance from the user and of a signal value corresponding to a number of photons returning towards the sensor per unit of time,
subsequent to the first capture and for each pixel, calculating a value of the standard deviation associated with the distance value, and a value of the standard deviation associated with the signal value and a confidence value, and
providing, to the neural network in association with each pixel, the distance, signal, and standard deviation values associated with the distance and with the signal, and the confidence value, and
generating, at the neural network, based on the values provided by the sensor, an estimate of a direction associated with the user.

16. A method comprising:
capturing, by a time-of-flight (ToF) sensor, an image scene comprising a user of a display, capturing comprising measuring, by each sensor pixel, a distance value, a signal value, and standard deviation values associated with the distance value and with the signal value, the sensor being further configured to generate, for each pixel, a confidence value;
providing, by the sensor to a microcontroller, the measurements performed by the pixels, the microcontroller comprising a neural network configured to estimate, based on the provided measurements, a direction describing the orientation of the head of the user; and
controlling, by the microcontroller, the display, or another circuit coupled to the microcontroller, based on the estimate of the orientation of the head.

17. The method according to claim 16, further comprising generating an attention value associated with the user, and controlling the brightness of the display further based on the attention value.

18. The method according to claim 16, further comprising measuring at each pixel a reflectance value, and generating the estimate of the orientation further based on the reflectance values.

19. The method according to claim 16, further comprising deactivating a backlight unit based on the estimate of the orientation.

20. The method according to claim 16, wherein the estimate of the orientation is a direction describing the orientation of the head of the user, among the North, North-East, North-West, East, West, and South directions, the North direction indicating that the user is facing the display, and the South direction indicating that the user has their back facing the display.
